(19) United States
(12) Patent Application Publication
(10) Pub. No.: US 2002/0147804 A1
(43) Pub. Date: Oct. 10, 2002

(54) System and method of remote maintenance management, corresponding management assembly and corresponding software product

(76) Inventors: Michel Cosmao, La Guimouserie (FR); Christophe Chevance, Rennes (FR)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/096,049

(22) Filed: Mar. 12, 2002

(30) Foreign Application Priority Data
Mar. 12, 2001 (FR) 0103310

(51) Int. Cl. G06F 15/173

(52) U.S. Cl. 709/223

(57) ABSTRACT

System and method of remote maintenance management, corresponding management assembly and corresponding software product

The present invention relates to a system 1 and a method of remote maintenance management via a communication network 2, of appliances Aj_k, A′j_k.

The system comprises modules for registering 11 and 21, modules for recording 12 and 22 information in databases BD_U, BD_C and BD_R, modules for managing 13 and 23 these bases, and modules for communicating 14 and 24 results of operating tests on the appliances via the network, respectively for users Uj, U′j and maintenance service providers Ci and Ri. The communication module 24 also communicates information contained in the user database BD_U to the providers Ci and Ri. The results of the tests make it possible to compile diagnostics regarding the state of operation of the appliances.

Application to a remote maintenance portal.

### TECHNICAL FIELD

The present invention relates to a system and a method of remote maintenance management via a communication network, such as for example the Internet, as well as to a maintenance management assembly comprising such a system and to a corresponding software product. It applies in particular to the embodying and implementation of an electronic maintenance portal.

### BACKGROUND

With the development of digital home networks, the risks of breakdowns or of technical problems are growing. Specifically, on the one hand, the appliances present in the home are more numerous than before and are interconnected with one another, in such a way that the failure of any one of them may have repercussions on the operation of the others. On the other hand, even in the absence of any breakdown, the replacement of a version of one of the appliances by another more recent version may pose problems of compatibility with the other appliances, penalizing the entire home network.

To remedy these difficulties, telediagnosis and/or telemaintenance services have been developed. They enable repairers to obtain remotely, via a communication network such as in particular the Internet network, information regarding malfunctions of the appliances and to analyse them, then possibly to intervene via this network in order to carry out repairs. Such services are appropriate in particular for updating software for operating the appliances, for example so as to remedy compatibility problems.

More specifically, maintenance portals have been proposed, such portals consisting of sites designed as points of entry to the Internet and offering maintenance services to users of appliances.

Thus, Japanese patent application JP2000-196769 (published on Jul. 14, 2000) discloses a maintenance and repair service system for domestic electrical appliances. A user of appliances accesses a home page of a server belonging to a maintenance service center, and signs up to a maintenance contract by recording the necessary information. This information is recorded in a client database of the center. In case of a failure of one of the appliances, detected by self-test devices incorporated into these appliances, the failure is signaled to an information management device which automatically calls the center. The latter then decides on the desirable mode of intervention.

This type of portal can be very practical for the users and the repairer, but it requires that the geographical layout of the repairer be related to the scope of the site, so that interventions are made possible at the clients' premises. Moreover, it demands that the repairer have a very extensive range of diagnostic and/or maintenance capabilities, so as to be able to intervene on various types of appliances, in their various versions. Otherwise, the users sign up to a subscription for services restricted to a few appliances only, with risks of generalized breakdown if one of the appliances connected to the home network cannot be repaired by the service center furnished with the server.

The document WO-99/65192 describes remote service platforms or gateways for local networks. These services can comprise in particular the updating of software, the monitoring of operations and the detecting of errors (cf. p.7, I.29 to p.8, I.2). Thus, the suppliers of services can, via network operators, load software associated with services onto a dedicated platform server, linked to at least one of the local networks (FIG. 2 of the document). This software controls or monitors devices of the local network concerned, thereby implementing the services.

A drawback of this technique resides in the requirement to install coherent systems at the level of the platforms, needing initial downloads of software and operations for making all the functionalities coherent.

### SUMMARY OF THE INVENTION

The present invention relates to a system for remote maintenance management via a communication network, enabling a very extensive regional layout as well as a very wide range of products which can form the subject of repairs.

The management system of the invention can also afford such advantages without entailing complications for the users as compared with existing systems, in particular by means of a simple registration.

Another advantage of the management system of the invention is that it allows dynamic growth of maintenance capabilities, both in geographical and hardware terms.

The invention also relates to a maintenance management assembly comprising a maintenance management system according to the invention, as well as a maintenance management method and a software product corresponding to the management system.

Accordingly, the subject of the invention is a system for remote maintenance management via a communication network, comprising:

a user module for registering, via the network, users of appliances for the maintenance of these appliances,

a user module for communication via the network to the management system, of results of operating tests on the appliances, these results making it possible to compile diagnostics regarding the state of operation of the appliances,

and a provider module for communication via the network to providers of maintenance services, of information regarding the users and the results of the operating tests on the appliances.

According to the invention, that management system comprises:

a user module for recording information regarding the users and the appliances in at least one user database,

a user module for managing the user database,

a provider module for registering via the network, providers of maintenance services of the appliances,

a provider module for recording information regarding the providers of maintenance services in at least one provider database,

and a provider module for managing the provider database, and in that the provider module for communication is designed in particular to communicate via the network to the providers of maintenance services, information contained in the user database.

The term “maintenance” is understood in the wide sense as a collection of operations making it possible to maintain the appliances in a given state or to give them back specified operating properties, including those with regard to their interconnections. It therefore encompasses not only mending or repairs, but also updates in relation to revamped versions (maintenance in relation to advances in techniques), including improvements to software versions and available resources. Moreover, the maintenance services considered may be partial and include diagnostic services only, the repair or updating operations being performed independently. They may include also only repair or updating services, based on diagnostics supplied with the results of operating tests.

The term “appliances” is understood to mean hardware objects intended to produce results, such as for example video recorders, televisions, personal computers (PC), portable telephones or cameras.

The providers can in particular be repairers, manufacturers and/or designers of software.

The system of the invention differs from the generally known systems in that it offers possibilities of registration and of obtaining information, to maintenance service providers. Thus, it constitutes a center for managing information, and possibly interventions, not only in respect of the users but also in respect of the service providers. On the other hand, the maintenance portals of the prior art are proprietary, each of the portals being controlled and monitored by a single maintenance service provider.

Relative to the embodiments disclosed in the document WO-99/65192, the management system of the invention is associated with the presence of a service providers registration module. In this way, a genuine portal is defined not only for the users of the appliances, but also for the service providers. On the other hand, in the prior document WO-99/65192, the configuration is frozen and the system does not permit the unrestricted registration of new providers. The latter can only be taken into account therein via an initialization step, which comprises the downloading of appropriate software to the platforms and its shared management. The system of the invention therefore offers great flexibility in the modifications of the service providers (introduction or removal of services). What is more, it contrasts suprisingly with the known concepts for taking into account several providers of maintenance services.

Thus, the management system of the invention permits the registration of several providers, by offering centralized management. This is especially advantageous for the users who may thus, preferably by virtue of a single registration, be furnished with the gamut of skills and territorial capabilities and techniques of the various providers. For their part, the maintenance service providers benefit from the enticement of a far wider clientele than that which they would have been able to reach via their resources alone.

The provider communication module steers the information and requests from the users to this or that provider depending on predefined criteria. This may involve in particular the proximity of repair centers, the choice of the user, specialist technical skills and/or contractual clauses (the appliances of a given brand being for example dealt with routinely by the manufacturer owning this brand or a repairer authorized by this manufacturer).

Preferably, the maintenance management system comprises a module for triggering via the network by the providers of maintenance services, self-tests in the appliances of the users and for communicating the results of those tests by the user and provider communication modules.

Thus, when a provider is informed of a problem at a user's premises, for example by e-mail or by telephone, he can himself trigger the operations required for the compilation of diagnostic.

Advantageously, the maintenance management system comprises a telemaintenance operations control module intended to allow the providers to perform those operations on the appliances via the network, after having compiled diagnostics as a function of the results of the tests.

The providers may thus intervene directly and remotely at the users' premises, at least in respect of some of the repairs and/or updates.

According to three forms of maintenance, advantageously combined, the latter comprises:

repairs of defective appliances;

updates of software for operating the appliances;

and updates of resources of the appliances.

The user modules are preferably designed to associate with at least some of the users respectively assemblies of the appliances, each of these assemblies forming a home network. The management system thus makes it possible to distinguish the local networks and to demonstrate relations between the various appliances of each of these networks. Furthermore, it enables centralized registration for each user, and not for each appliance.

Preferably, the communication modules are designed to communicate the results of the tests pertaining on the one hand to the internal operation of the appliances and on the other hand to the operation of interconnections between the appliances of each of the home networks.

The appliances of a home network are preferably linked by a bus of the IEEE 1394 type. Specifically, the interconnection of the appliances is then compatible with an individual discussion of each of them with the management system.

The communication network preferably comprises a digital network, preferably the Internet network (the management system of the invention then offers a maintenance portal).

The invention also relates to an assembly for remote maintenance management via a communication network, comprising a system for maintenance management via the network and user interface units, the management system being designed to allow remote maintenance of appliances of the users.

According to the invention, the management system complies with any one of the embodiments of the invention and the management assembly also comprises maintenance services provider interface units, the management assembly being designed to allow the maintenance by means of the provider interface units.

The invention also applies to a method of remote maintenance management via a communication network, in which, by means of a maintenance management system:

users of appliances are enabled to register via the network for the maintenance of those appliances,

results of operating tests on the appliances are communicated via the network to the management system,

and information regarding the users and the results of the operating tests on the appliances, are communicated via the network to providers of maintenance services.

According to the invention, by means of the management system:

information regarding the users and the appliances is recorded in at least one user database and the database is managed, the management system having access to the user database,

maintenance service providers are enabled to register via the network for the maintenance of the appliances,

information regarding the providers is recorded in at least one provider database and the database is managed,

and the information contained in the user database, is communicated via the network to the providers.

This method is preferably implemented by means of a maintenance management system complying with any one of the embodiments of the invention.

The subject of the invention is also a software product comprising functionalities of management of maintenance of appliances via a communication network.

According to the invention, these functionalities are designed to embody the modules of a management system complying with any one of the embodiments of the invention.

The expression, “software product” is understood to mean the materialization of an item of software on any medium, such as in particular paper, magnetic medium (hard disk, cassettes, diskettes, etc.) or optical medium (DVD, etc.), or else in the form of signals.

### BRIEF DESCRIPTION OF THE DRAWINGS

The invention will be better understood and illustrated by means of the following examples of embodiments and implementations, which are in no way limiting, with reference to the appended figures in which:

FIG. 1 is a diagram showing the interactions between a management system complying with the invention and its environment (databases, communication network, users, service providers);

FIG. 2 is a basic diagram detailing the management system of FIG. 1 and its interactions with a user, a service provider and the databases;

FIG. 3 illustrates a home network connected to the management system of FIGS. 1 and 2 by a user interface;

FIG. 4 diagrammatically shows the relations of the management system of FIGS. 1 to 3 with various users and service providers, via the communication network;

FIG. 5 details a provider interface, using the management system of FIGS. 1 to 4;

FIG. 6 shows a repairer access control window of the interface of FIG. 5;

FIG. 7 shows a client access control window of the interface of FIG. 5;

FIG. 8 shows a home network display window of the interface of FIG. 5;

FIG. 9 shows an information window relating to the properties of an appliance, of the interface of FIG. 5;

FIG. 10 shows a remote functions window in respect of an appliance, of the interface of FIG. 5;

FIG. 11 shows a window for downloading a file intended for remote functions in respect of an appliance, of the interface of FIG. 5;

FIG. 12 shows a standby window of the interface of FIG. 5;

FIG. 13 shows a client information window of the interface of FIG. 5;

FIG. 14 shows a window for displaying isochronous links of the interface of FIG. 5.

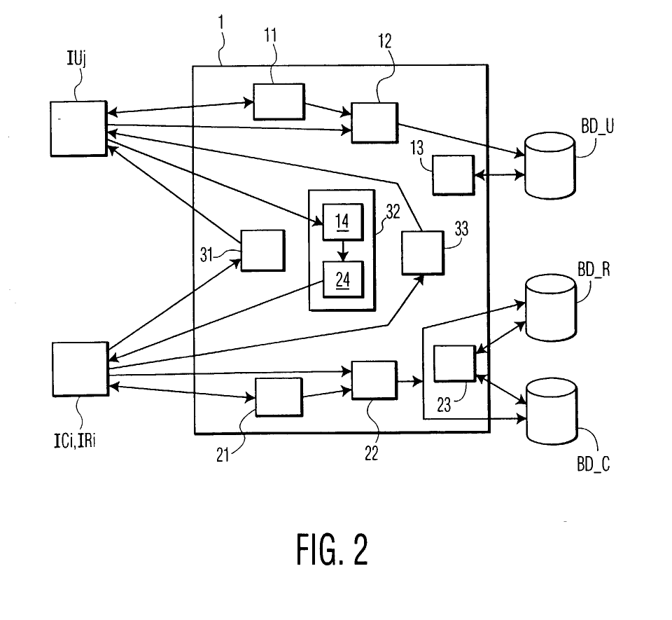

In FIG. 2, the links of the various modules with the modules for managing the databases have not been represented, so as to make reading clearer.

### DETAILED DESCRIPTION OF PREFERRED EMBODIMENTS

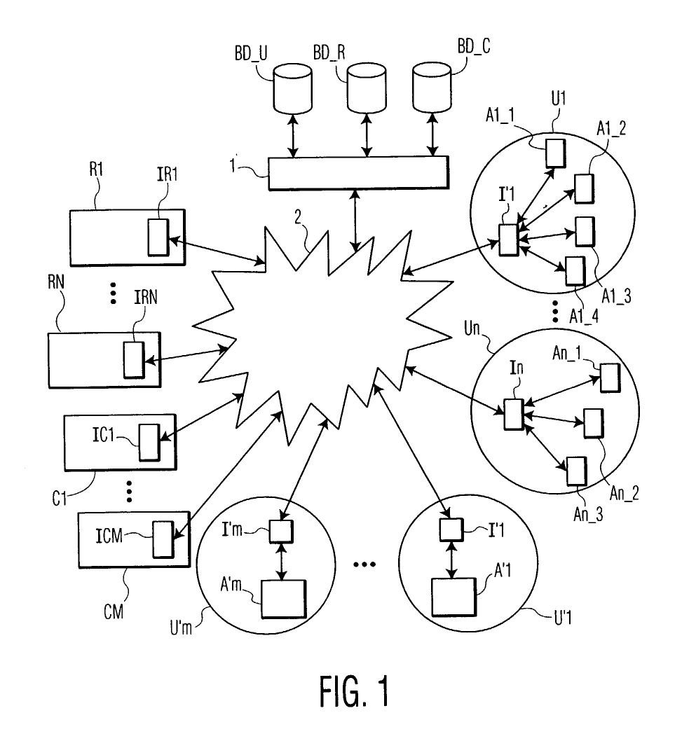

A remote maintenance management system 1 (FIG. 1), in the form of a portal installed in a server, is linked to a communication network such as the Internet network 2. It allows users Uj (j=1 . . . n) furnished with home networks comprising several appliances Aj_k and users U′j (j=1 . . . m) associated with unique appliances A′j to sign up to a maintenance subscription with the system 1, via the network 2. The users Uj and U′j communicate with the system 1 respectively by means of user interfaces Ij and I′j. The system 1 is linked to a user database BD_U, storing all the useful information regarding the registered users Uj, U′j and regarding their appliances Aj, A′j.

The system 1 also allows maintenance service providers such as manufacturers Ci (i=1 . . . M) and repairers Ri (i=1 . . . N), to register therewith, by means of provider interfaces respectively referenced ICi and IRi. The system 1 write-accesses and read-accesses a database of manufacturers BD_C and a database of repairers BD_R, in which is stored all the useful information regarding the service providers.

More precisely, the maintenance management system 1 comprises (FIG. 2) user-only modules, provider-only modules and modules of links between them. Thus:

a user subscription module 11 allows any user Uj to register with the maintenance portal via the network 2;

a user recording module 12 for recording information is designed to record in the user database BD_U the information obtained from the user Uj regarding himself (name, address, repairer preferences etc.) and his appliances Aj_k (types, brands, location in the home etc.) and technical information regarding the appliances Aj_k from other sources (for example the manufacturers);

a user management module 13 for managing the user database BD_U undertakes the transfers of information between this database BD_U and the management system 1;

and a user module for communication 14 via the network 2 is provided for communicating results of operating tests on the appliances Aj_k to the system 1; these results either themselves already constitute diagnostics regarding malfunctions of the home network of the user Uj, or allow the providers to compile such diagnostics.

Similarly, the system 1 also comprises:

a provider subscription module 21 enabling a repairer Ri or manufacturer Ci maintenance service provider to register with the maintenance portal via the network 2;

a provider recording module 22 for recording information regarding the provider Ri or Ci in the database of repairers BD_R or manufacturers BD_C, this information pertaining for example to the geographical layout of the provider's maintenance workshops, the appliances catered for by type and/or by brand, the nature of the facilities provided etc.;

a provider management module 23 for managing the databases of repairers BD_R and manufacturers BD_C, catering for the transfers of information between these databases and the management system 1;

and a provider module for communication 24 via the network 2 designed to select the provider(s) Ci or Ri concerned and to communicate to them the results of operating tests on appliances Aj₁₃ k from the system 1; the user 14 and provider 24 communication modules constitute a unit 32 for communicating the test results.

The system 1 also comprises:

a module 31 for triggering self-tests in the appliances Aj_k of the user Ui, by the provider Ci or Ri and via the network 2;

and a module 33 for controlling telemaintenance operations by the provider Ci or Ri of the appliances Aj_k of the user Ui.

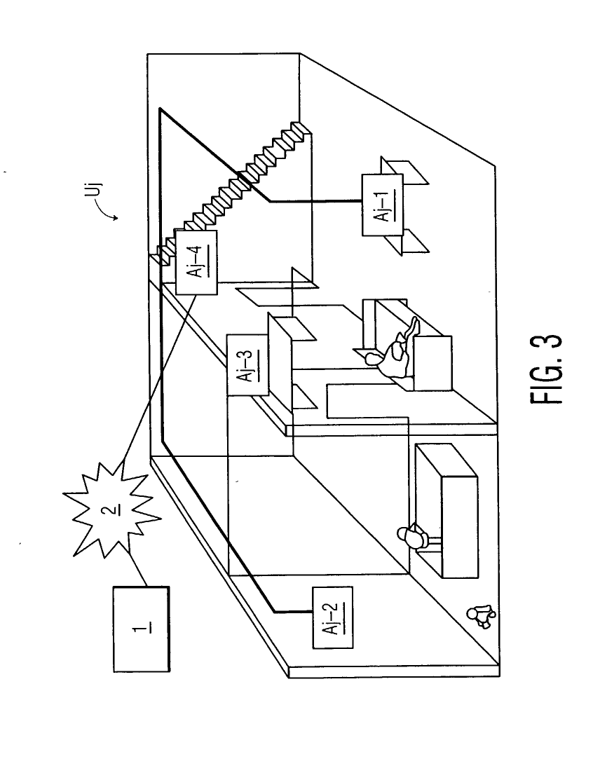

By way of illustration (FIG. 3), the home network of the user Uj comprises a first television Aj_1 situated in the lounge and in front of which the owner of the apartment is seated, a digital camera Aj_2 placed in a children's room and enabling him to monitor his baby, a second television Aj_3 installed in the kitchen and a personal computer Aj_4 acting as connection gateway via the network 2 to the portal of the maintenance management system 1.

When for example the owner does not succeed in displaying on the second television Aj_3 the video obtained with the camera Aj_2, he calls a maintenance workshop by telephone or via the Internet network 2 and requests a remote diagnosis of the problem. From his maintenance workshop, an employee then logs onto the home network of the user Uj by means of the management system 1 and executes diagnostic software on this network and on all the connected appliances Aj_1 to Aj_4. This software enables him to ascertain the interconnection status and the internal status of all these appliances Aj_k, the constructors and types of appliances Aj_k, the hardware and/or software version. Moreover, it permits him to trigger self-test programmes of the appliances Aj_k and to read the results of the tests.

The repairer can then call the user Uj back or send him an e-mail and give him the result of his assessment. For example, he indicates that the camera Aj_2 is furnished with an old version of software and proposes to update this software directly via the network 2. Once a downloading of the new software version has been performed, the owner can again see his baby normally from the kitchen on the screen of the television Aj_3.

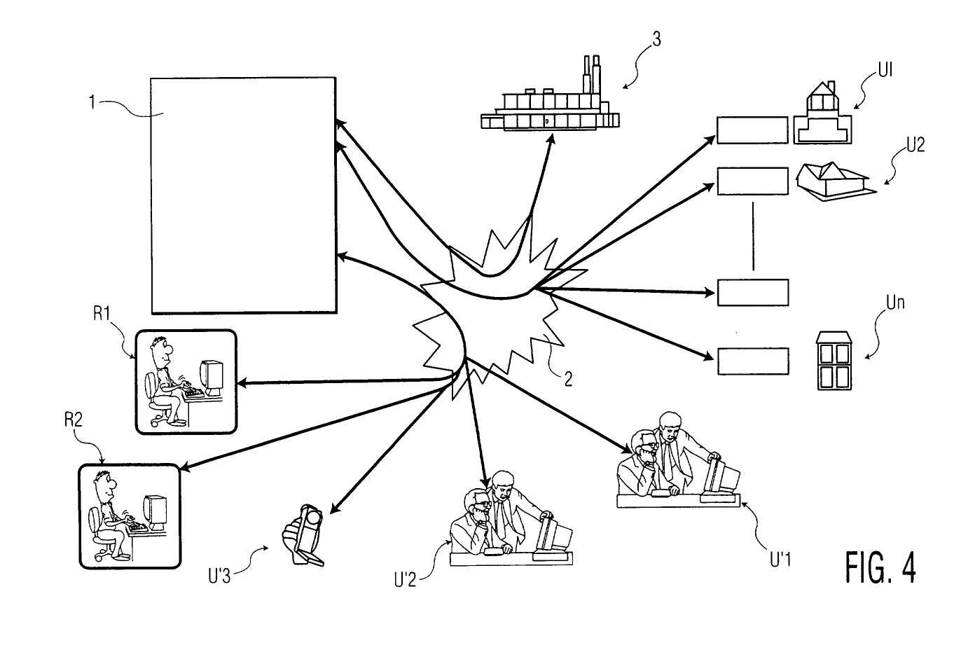

The management system 1 thus enables the benefit of its services to be afforded via the network 2 (FIG. 4) to various users U1 . . . Un furnished with a home network or users U′j associated with a single appliance A′j, such as roaming clients U′1 et U′2 or clients U′3 with portables, as well as to various providers Ci and Ri such as repair workshops R1 and R2. It is moreover linked via the network 2 with a manager 3, which can in particular have functions of broadcasting, administration and billing.

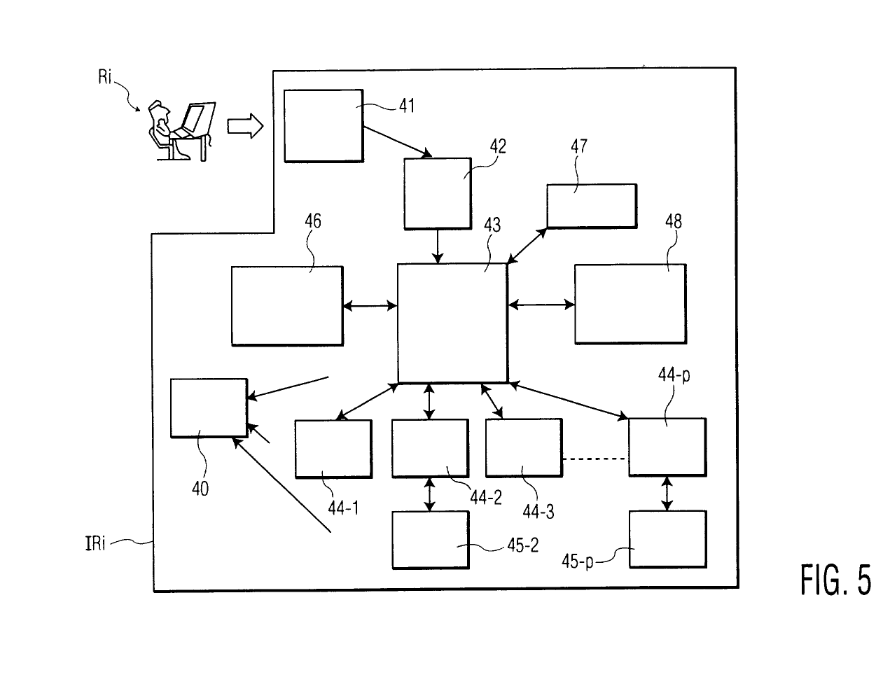

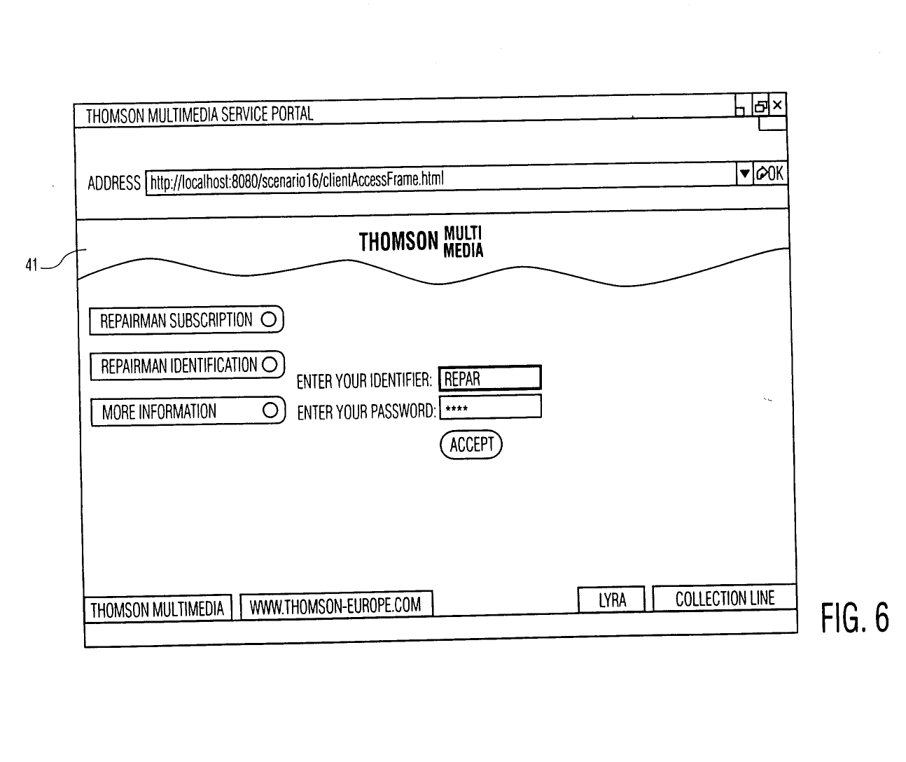

A particular embodiment of a provider interface IRi or ICi will now be detailed, with reference to FIGS. 5 to 14. By way of example, it relates to a repairer Ri. The interface IRi (FIG. 5) comprises a repairer access control window 41 (FIG. 6), which allows the repairer Ri to input his access identifier (login) and his password.

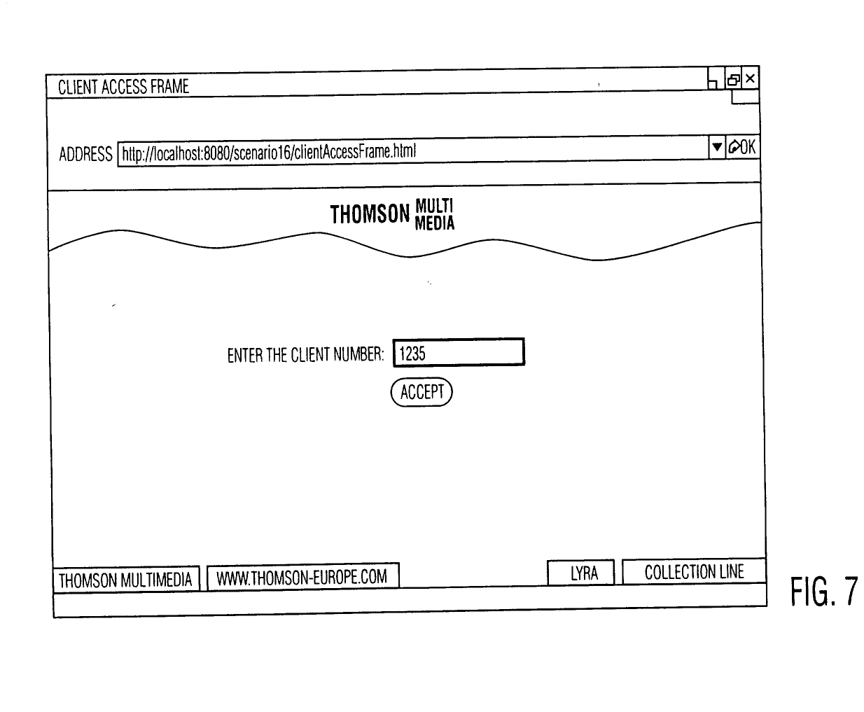

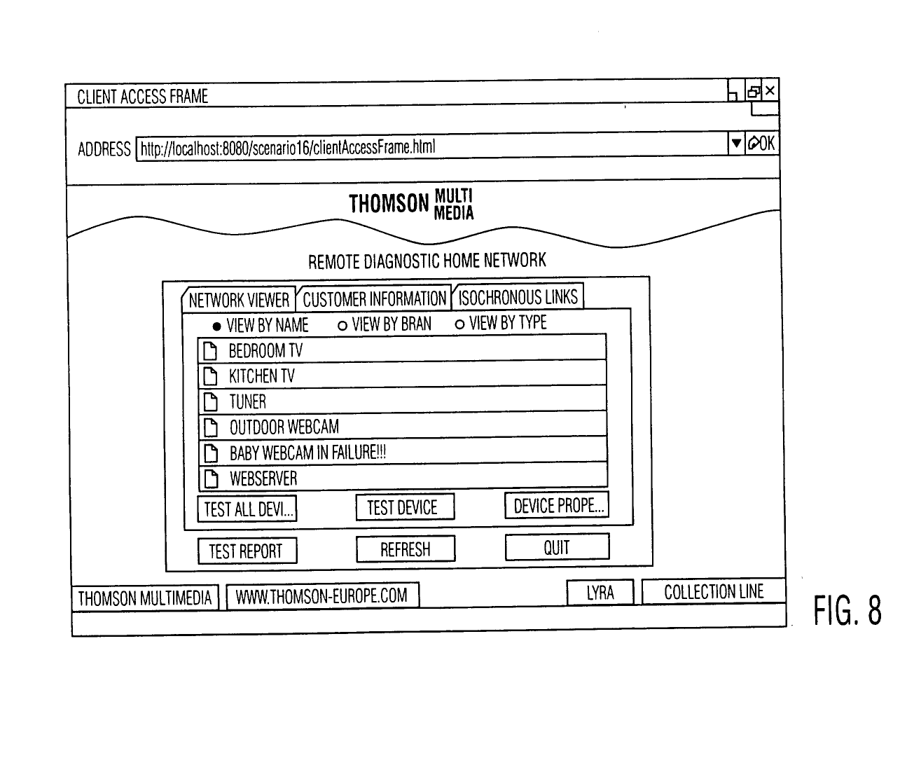

It also comprises a client access control window 42 (FIGS. 5 and 7), by means of which it subsequently inputs the identification information of the client for whom it is to make a diagnosis. A network display window 43 allows the repairer Ri to have a view of the home network of the user concerned (“Network Views” button). The repairer Ri can select a view based on names (FIG. 8), brands or types of appliances.

The repairer Ri can then globally launch self-tests on all the appliances connected to the home network by selecting an appropriate button of the window 43 (“Test all Devices” button). If an error is detected, it appears on the chosen representation with an error message (FIG. 8). The repairer Ri can also launch a simple self-test on a specific selected appliance (“Test Device” button). In the window 43, a “Refresh” button makes it possible to update the information regarding the home network and a “Quit” button makes it possible to quit the application of diagnosis with the client.

Moreover, a “Test Report” button allows the creation of a text file containing all the information regarding the home network with its appliances, this file possibly being printed or sent to the client. This possibility corresponds to a report window 47 (FIG. 5).

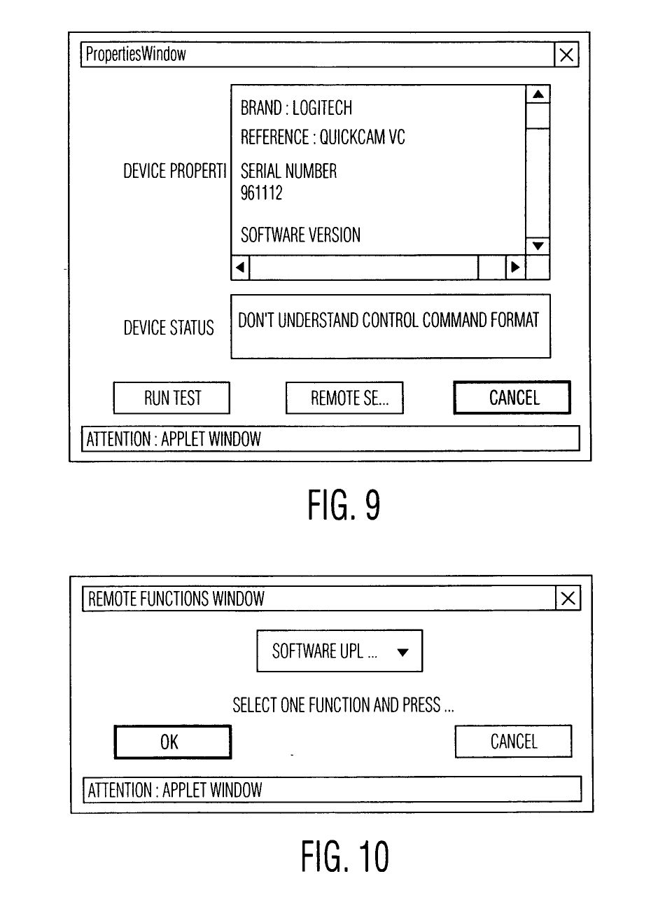

In each representation, it is possible to select an appliance and to view its properties and the results of self-tests by selecting a “Device Properties” button. The repairer then accesses an information window 44_k regarding the properties of the appliance Uj_k considered (FIGS. 5 and 9). It thus displays the properties of the appliance and its status, resulting from the self-test. Moreover, it can rerun a self-test and reupdate the results by selecting a “Run Test” button. A “cancel” button enables it to return to the view of the home network.

From the information window 44_k relating to the properties of the appliance Uj_k, the repairer Ri can also access a remote functions window 45_k in respect of the appliance Uj_k (FIGS. 5 and 10) by pressing a “Remote Functions” button. He can then see all the functions available in respect of this appliance Uj_k and launch one of these functions by means of an “OK” button.

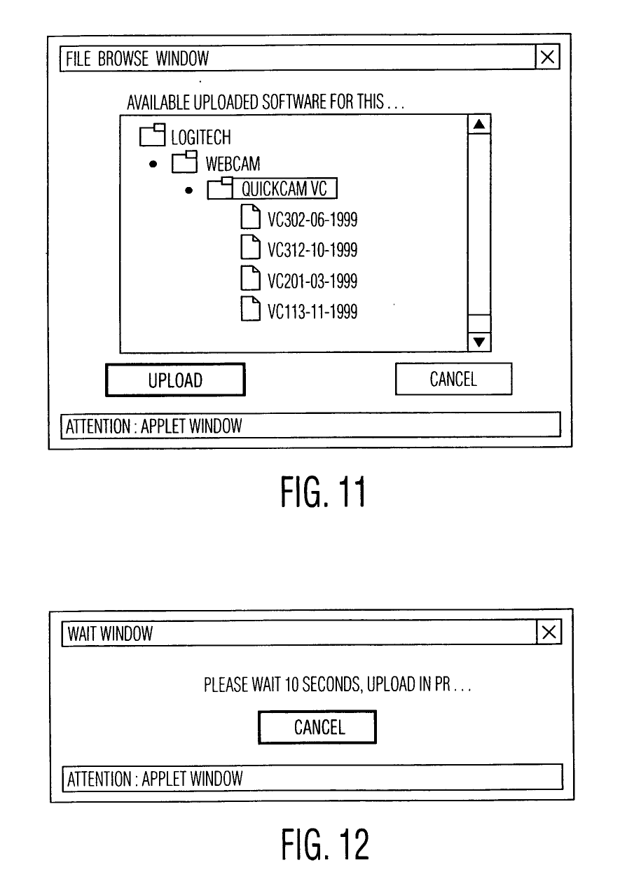

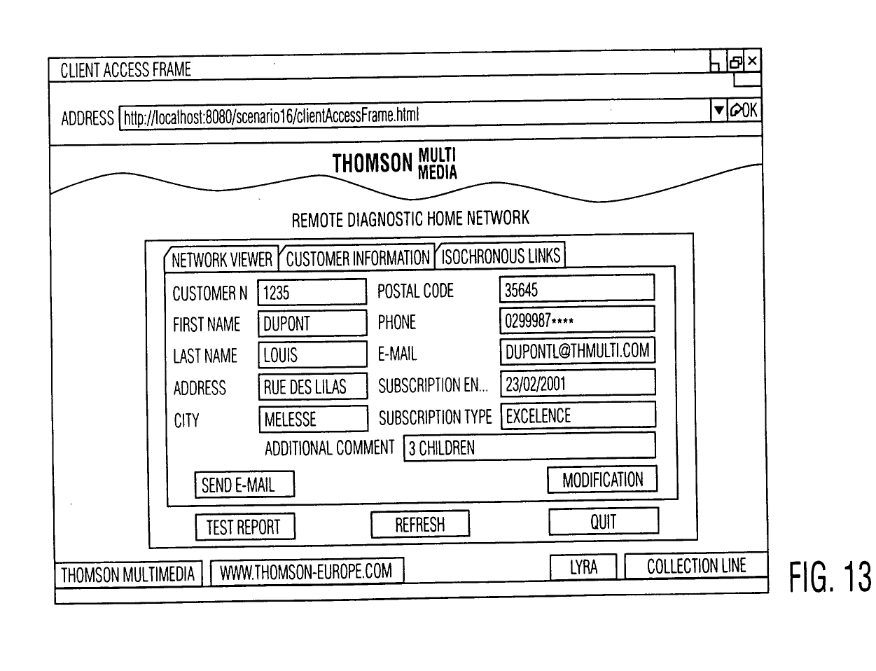

If a file name is required in order to launch the function, a file navigator window 49_k appears (FIG. 11). It is then possible to select the desired file and to download it (“Upload” button), then to confirm with the “OK” button of the window 45_k. During downloading, a standby window 40 (FIGS. 5 and 12) appears.

The repairer Ri can access the information regarding the user Ui by selecting a “Customer Information” button of the window 43. He then obtains a client information window 46 (FIGS. 5 and 13), which enables him in particular to update certain information by selecting a “Modify” button and by modifying some fields.

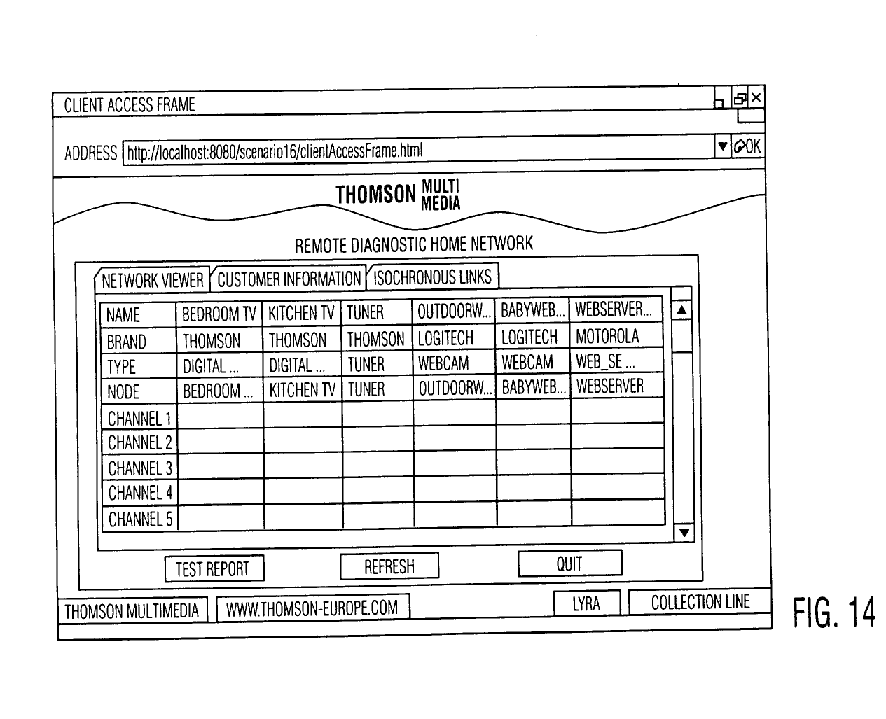

Moreover, he can also display isochronous links by selecting an “Isochronous links” button of the window 43. He thus obtains a window 48 for displaying isochronous links (FIGS. 5 and 14) representing in a table the specific features of the input/output streams for each appliance.

1. System for remote maintenance management via a communication network, comprising:
a user module for registering, via the network, users of appliances for the maintenance of said appliances,
a user module for communication via said network to the management system, of results of operating tests on said appliances, said results making it possible to compile diagnostics regarding the state of operation of said appliances,
and a provider module for communication via said network to providers of maintenance services, of information regarding said users and said results of the operating tests on said appliances,
characterized in that said management system comprises:
a user module for recording information regarding said users and said appliances in at least one user database,
a user module for managing the user database,
a provider module for registering via the network, providers of maintenance services of said appliances,
a provider module for recording information regarding said providers of maintenance services in at least one provider database,
and a provider module for managing the provider database,
and in that the provider module for communication is designed in particular to communicate via said network to the providers of maintenance services, information contained in the user database.

2. Maintenance management system according to claim 1, characterized in that it comprises a module for triggering via said network by the providers of maintenance services self-tests in the appliances of said users and for communicating the results of said tests by the user and provider communication modules.

3. Maintenance management system according to claim 1, characterized in that it comprises a telemaintenance operations control module intended to allow said providers to perform said operations on said appliances via said network, after having compiled diagnostics as a function of the results of the tests.

4. Maintenance management system according to claim 1, characterized in that said maintenance comprises repairs of the defective appliances.

5. Maintenance management system according to claim 1, characterized in that said maintenance comprises updates of software for operating said appliances.

6. Maintenance management system according to claim 1, characterized in that said maintenance comprises updates of resources of said appliances.

7. Maintenance management system according to claim 1, characterized in that the user modules are designed to associate with at least some of said users respectively assemblies of said appliances, each of said assemblies forming a home network.

8. Maintenance management system according to claim 7, characterized in that the communication modules are designed to communicate the results of the tests pertaining on the one hand to the internal operation of said appliances and on the other hand to the operation of interconnections between the appliances of each of the home networks.

9. Maintenance management system according to claim 1, characterized in that the communication network comprises a digital network, preferably the Internet network.

10. Assembly for remote maintenance management via a communication network, comprising a system for maintenance management via said network and user interface units, the management system being designed to allow remote maintenance of appliances of said users,
characterized in that said management system complies with claim 1 and in that the management assembly also comprises maintenance services provider interface units, said management assembly being designed to allow said maintenance by means of said provider interface units.

11. Method of remote maintenance management via a communication network, in which, by means of a maintenance management system:
users of appliances are enabled to register via the network for the maintenance of said appliances,
results of operating tests on said appliances are communicated via the network to said management system,
and information regarding said users and said results of the operating tests on said appliances, are communicated via the network to providers of maintenance services,
characterized in that by means of said management system:
information regarding said users and said appliances is recorded in at least one user database and said database is managed, said management system having access to the user database,
maintenance service providers are enabled to register via the network for the maintenance of said appliances,
information regarding said providers is recorded in at least one provider database and said database is managed,
and said information contained in said user database, is communicated via the network to said providers,
said method being preferably implemented by means of a maintenance management system complying with claim 1.

12. Software product comprising functionalities of management of maintenance of appliances (Aj_k, A′j_k) via a communication network,
characterized in that said functionalities are designed to embody the modules of a management system complying with claim 1.
